(19) United States
(12) Patent Application Publication
(10) Pub. No.: US 2025/0125755 A1
(43) Pub. Date: Apr. 17, 2025

(54) METHOD FOR CLOSED-LOOP CONTROL OF ACTUATORS WITH CAPACITANCE AS PART OF THE FEEDBACK

(71) Applicant: CHIPSEMI SEMICONDUCTOR (NINGBO) CO., LTD., Ningbo (CN)

(72) Inventors: Yibin Wu, Ningbo (CN); Juiming Ni, Ningbo (CN); Bo Xia, Ningbo (CN); Yaoguo Zhang, Ningbo (CN); Yulin Zhang, Ningbo (CN)

(21) Appl. No.: 18/488,018

(22) Filed: Oct. 16, 2023

(51) Int. Cl. H02P 25/034; B06B 1/02; G06F 3/01

(52) U.S. Cl. CPC H02P 25/034; B06B 1/0261; B06B 2201/53; B06B 2201/55; G06F 3/016

(57) ABSTRACT

Embodiments provide methods for controlling an actuator based on closed-loop feedback of capacitance measured between a rotor plate attached to a rotor and a stator plate attached to a stator. The methods involve measuring capacitance at a predetermined sampling rate using a capacitance sensing unit operationally connected to an actuator. The capacitance measurement is made between the rotor plate and the stator plate of the actuator and is subsequently stored. The methods further include calculating the capacitance change between two consecutive capacitance measurements using a processing unit operationally connected to an actuator. Based on calculated capacitance changes, a control signal is generated to regulate the operation of the actuator.

### FIELD OF THE INVENTION

The present application generally pertains to control of actuators, and more particularly focus on a closed-loop control of actuators with capacitance as part of the feedback.

### BACKGROUND OF THE INVENTION

An actuator is a component of a machine that is responsible for moving and controlling a mechanism or system, for example, by opening a valve. An actuator requires a control signal and a source of energy. The control signal is relatively low energy and may be electric voltage or current, pneumatic, or hydraulic fluid pressure, or even human power. The source of energy may be an electric current, hydraulic pressure, or pneumatic pressure. When the actuator receives a control signal, it responds by converting the source of energy into mechanical motion.

However, the existing actuators rarely have closed-loop control, and those that do usually rely on the detection of back electromotive force or the use of Hall sensors to detect changes in magnetic flux to determine the state (e.g., current position) of the actuator's rotor. However, not all actuators are driven by magnetic coils, such as piezoelectric ceramic actuators, so not all actuators can detect back electromotive force and magnetic flux.

An electrical actuator is a device that converts electrical energy into mechanical motion. It is widely used in various applications where precise control and positioning are required. Electrical actuators are highly versatile and find applications in various fields, including robotics, industrial automation, automotive systems, aerospace, and many more. Their ability to provide precise and controlled motion makes them valuable components in modern control systems. Electrical actuators present distinct advantages compared to other actuator types, such as pneumatic or hydraulic systems, as they deliver more precise and controlled motion.

By incorporating a simple capacitance detection and measuring component into existing electrical actuators, the actuator's rotor state including its position can be rapidly and precisely determined by analyzing the capacitance measurements, which reflect its various states and positions. Feeding this information back to the control system as a reference allows for faster and finer adjustment to a change in the control signals by the actuator. In turn, it allows more precise and efficient control of the actuator.

### BRIEF SUMMARY OF THE INVENTION

In accordance with the present disclosure, a method for controlling an electrical actuator is provided such that measurements of capacitance are used as feedback for the closed-loop control of various functions of an actuator. In some embodiments, a rotor plate attached to a rotor and a stator plate attached to a stator can be used to create a capacitance. When the rotor moves, a distance change of the rotor leads to changes in the capacitance measured between the rotor plate and the stator plate. The variation in capacitance is then fed back to the actuator controller, enabling rapid initiating or braking of the actuator, preventing trailing effects and residual vibrations, and providing a more clean and precise vibration feedback.

In some embodiments, the method involves moving the rotor in a predetermined direction by a predefined distance, a capacitance sensing circuit measuring the capacitance between the rotor and stator plates. A processing unit then computes the change in rotor position based on the capacitance readings from the sensing circuit. The processing unit further determines whether this change aligns with the predefined distance. Finally, a rotor drive block governs the rotor's actions based on whether the observed distance change matches the predefined distance.

### BRIEF DESCRIPTION OF THE DRAWINGS

FIG. 1 illustrates a high-level application system using an actuator with a closed-loop feedback of capacitance measurement, according to an exemplary embodiment of the present disclosure.

FIG. 2 illustrates an exemplary application system using an LRA actuator according to some embodiments of the present disclosure.

FIG. 3 illustrates another exemplary application system using a piezo ceramic actuator according to some embodiments of the present disclosure.

FIG. 4 illustrates a method for improved braking control of an LRA actuator based on capacitance feedback according to some embodiments of the present disclosure.

### DETAILED DESCRIPTION OF THE INVENTION

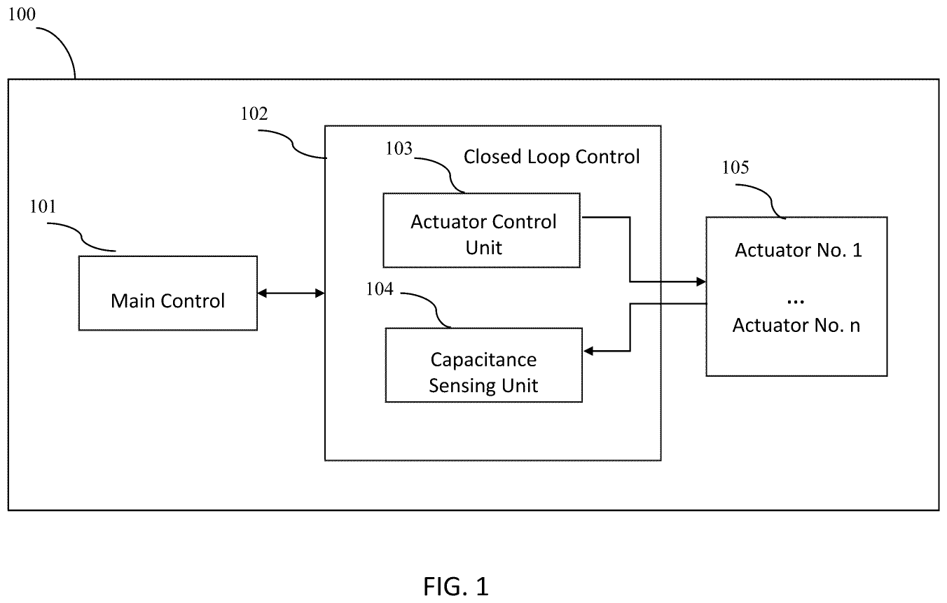

FIG. 1 illustrates an application system 100 using an actuator with a feedback of capacitance measurement to accomplish a closed-loop control of the actuator, according to an exemplary embodiment of the present disclosure. In FIG. 1, system 100 comprises a main controller 101, which is operatively connected to a closed-loop controller 102 through an interface (e.g., I2C, USB, SPI, UART, I3C or other similar type of bus). Closed-loop controller 102 controls one or more actuators 105.

In some embodiments, closed-loop controller 102 includes an actuator control unit 103 and a capacitance sensing unit 104. Closed-loop controller 102 can determine the precise location of a rotor of one or more actuators 105. This location information is then fed to main controller 101. Depending on the specifics of an application, the main controller 101 then sends the appropriate control signals to an actuator control unit 103, which in turn controls the movement of an actuator 105, including but not limited to modifications of vibration and braking of the actuator 105.

In FIG. 1, the main controller 101 may be for any equipment or device, such as a mobile phone, a computer, a headphone, an interface in a car.

In FIG. 1, closed-loop controller 102 has the function of driving the actuators 105 and performing capacitance detection and measurement. But in practice, closed-loop controller 102 may be implemented in a single chip according to some embodiments. In other embodiments, closed-loop controller 102 may be an integrated system consisting of two or more chips.

In FIG. 1, the actuators 105 are devices capable of actuation, such as piezoelectric actuators, electromagnetic actuators, voice coil motors, shape memory alloys, electroactive polymers, solenoids, Eccentric Rotating Mass (ERM) motors, or Linear Resonant Actuators (LRA).

According to some embodiments of the present disclosure, the piezo ceramics can also be used as a pressure sensor in addition to be an actuator (e.g., 105) as illustrated in FIG. 1. Here, closed-loop controller 102 for piezoelectric ceramic actuator 105 utilizes the capacitance sensing unit 104 to monitor the operational status of the piezoelectric ceramic actuator 105 and the intensity of the pressure exerted on its surface. This data is then relayed as feedback to the main controller 101. Depending on the requirements of its ultimate application, the main controller 101, through the piezoelectric ceramic actuator control unit 103, modulates the vibration of the actuator 105. This modulation encompasses various functions including, but not limited to, vibration effect adjustment and vibration braking.

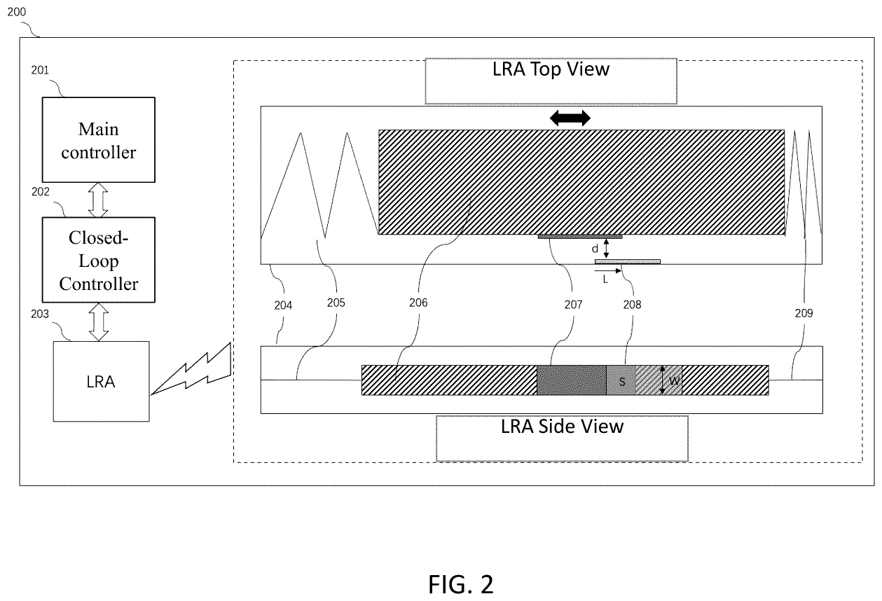

FIG. 2 illustrates an exemplary application system 200 using an LRA actuator according to some embodiments of the present disclosure. System 200 comprises the main controller 201, actuator controller 202, LRA 203. FIG. 2 shows both the top view and the side view of LRA203.

Although not shown in FIG. 2, closed-loop actuator controller 202 usually comprises an LRA control unit and a capacitance sensing unit. According to some embodiments, in the LRA 203 (taking the X-axis LRA for ease of description), the main components include: housing shell 204, springs 205 and 209, rotor 206, electrode plates 207 and 208, where electrode plate 207 is attached to rotor 206, and electrode plate 208 is attached to housing shell 204.

A capacitance C is formed between the two electrode plates 207 and 208, and actuator controller 202 stores the static capacitance value C₀ (i.e., when rotor 206 is in its null position). Actuator controller 202 may also store the maximum amplitude of vibration, which is the maximum distance (Lₘₐₓ) that rotor 206 moves from its null (or equilibrium) position during its vibrational motion in some embodiments according to the present disclosure. Lₘₐₓ is used to ensure that the actuator is not overdriven or that it does not ‘collide’ (e.g., making noise by hitting the casing of the LRA), reducing the working lifespan of the LRA. When it is found that a measured L is already greater than Lmax, it indicates that a mechanical redesign of the LRA is due, including possible changes in mass and spring constant. Therefore, based on the actual measured L, we adjust the driving voltage, driving frequency, etc., to make the LRA actuator move within the maximum distance, which is Lₘₐₓ.

In FIG. 2, when main controller 201 signals actuator controller 202 to start LRA 203, rotor 206 begins to move, the overlapping area between the two electrode plates 207 and 208 will change. The capacitance Cₘ between these two electrode plates 207 and 208 is measured.

Because the distance d between the two electrode plates does not change, the change in overlapping area ΔS can be determined through the change in capacitance ΔC as shown in equations (1) and (2) below.

$$Δ C = {C}_{0} - {C}_{m} \qquad ( 1 )$$

Where C₀ is the capacitance measured when rotor 206 is in its null position and not moving. Cₘ is the capacitance measured at the time of measurement.

$$Δ S = \frac{4 π kd}{ε} Δ C \qquad ( 2 )$$

Where ΔC is the change in capacitance, ΔS is the change in overlapping area between the two electrode plates 207 and 208, dis the distance between electrode plate 207 and electrode plate 208, & represents the relative dielectric constant of the medium, and k is the electrostatic force constant.

$$L = \frac{Δ S}{W} = \frac{4 π kd}{ε W} Δ C \qquad ( 3 )$$

Here, same as in equation (2), ΔC is the change in capacitance, ΔS is the change in overlapping area between the two electrode plates 207 and 208, d is the distance between electrode plate 207 and electrode plate 208, ε represents the relative dielectric constant of the medium, and k is the electrostatic force constant. In addition, L is the moving distance of rotor 207 from its null position with respect to stator 208.

According to some embodiments, during the operation, the rotor position relative to actuator null position can be determined based on the measured capacitance changes. After receiving the position information of the rotor of actuator LRA 203, actuator controller 202 compares this location with an expected location value which is predetermined. If the determined position does not match the expected value, the actuator controller 202 may adjust actuator working parameters so that the operation will meet expectation next time. For example, in normal circumstances, LRA is driven with the expected operating parameters, resulting in an anticipated amplitude (vibration distance L). However, in practical systems, we may encounter situations where the expected operating parameters do not achieve the anticipated amplitude due to changes in mechanical structure or variations in spring constants. Therefore, it is necessary to adjust the operating parameters such as the voltage or frequency of the driving signal.

Examples of the working parameters include but are not limited to the resonance frequency, amplitude, driving voltage, waveform, duty cycle, the Q-factor, mechanical load, and frequency range. Here, the resonance frequency is the natural frequency at which the LRA vibrates most efficiently. It depends on the LRA's mechanical design, including the mass and spring constants. To achieve optimal performance, LRAs are typically driven at or near their resonance frequency. Operating above or below resonance may result in reduced efficiency and amplitude.

Amplitude refers to the extent of movement or vibration produced by the LRA. It is typically measured in millimeters (mm). The amplitude of vibration is influenced by the amplitude of the driving signal applied to the LRA.

The driving voltage, often referred to as the voltage amplitude, is the magnitude of the electrical signal applied to the LRA. It determines the force and amplitude of vibration.

The waveform of the electrical signal applied to the LRA affects the resulting vibrations. Common waveforms include sinusoidal, square, or complex waveforms. The waveform's frequency, amplitude, and phase can all be adjusted to produce desired haptic effects.

Duty cycle refers to the fraction of time that the LRA is actively vibrating compared to the total cycle time. It is often expressed as a percentage. Controlling the duty cycle can help manage power consumption and thermal considerations while delivering specific haptic effects.

The Q-factor represents the sharpness of the resonance peak in the LRA's frequency response. Higher Q-factors indicate a more defined resonance peak. A higher Q-factor allows for a more efficient and selective excitation of the resonance frequency.

The mechanical load applied to the LRA, such as the mass of the attached object or the device housing, can affect its performance. It may alter the resonance frequency and amplitude.

Some LRAs are designed to operate within a specific frequency range. Maintaining this range is essential for achieving desired haptic effects and ensuring compatibility with the application.

As shown in the formula (1)-(3) above, the capacitance and the change of distance have a linear relationship, so the drive parameters (including the distances changed) and the capacitance values (or change of capacitances) are usually paired and stored in a lookup table.

In some other embodiments, the actuator controller 202 may instead pass the determined location value to the main controller 201 and wait for instruction from main controller 201 as to what needs to be done if the measured location value does not match the expected value.

In some embodiments, the actuator controller 202 may take the measurements of the capacitance at different times and based on the capacitance changes to make corresponding adjustments of the control signal to achieve more precise and efficient control of the actuator.

Regardless, through this closed-loop control with the feedback of measured capacitances, the LRA actuator can have an improved performance and efficiency, such as effectively avoid trailing or aftershocks, achieve rapid braking, or accurately identify the LRA actuator's F₀ (resonant frequency).

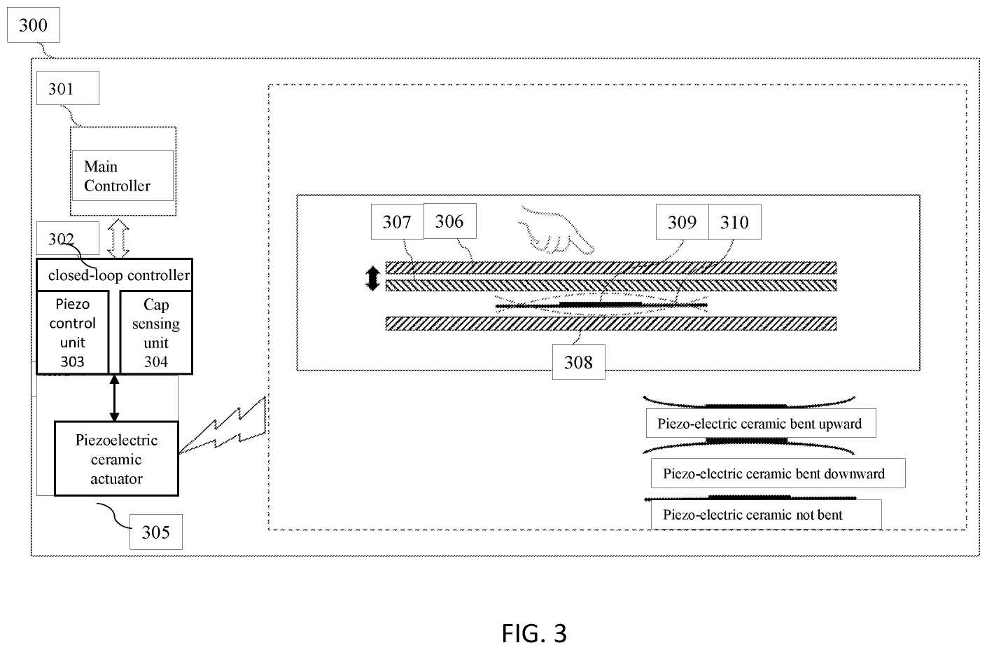

FIG. 3 illustrates another exemplary application system 300 using a piezoelectric actuator instead, according to some embodiments of the present disclosure.

Similar to the discussion with respect to LRA above, the relationship of the capacitance and the distance between the two electrodes for a given piezo ceramic can be mathematically summarized by the following formula.

$$C = \frac{ε}{4 π kd} S \qquad ( 4 )$$

Where ε is the dielectric constant of the medium, k is an electrostatic constant, S is the overlapping area between two electrode plates, d is the vertical distance between the two electrode plates. The dielectric constant is an inherent physical quantity of ceramics. For the same ceramic, its dielectric constant is unchanged.

When the piezoelectric ceramic is subjected to external force, it will cause deformation, thereby changing the distance d between the electrode plates. As a result, the capacitance will change. The greater the pressure, the greater the deformation, and the greater the change in capacitance.

Returning to FIG. 3, 300 is a piezoelectric ceramic vibration feedback touchpad according to some embodiments of the present disclosure. System 300 includes: main controller 301, closed-loop control 302, piezoelectric ceramic control unit 303, capacitance sensing unit 304, piezoelectric ceramic actuator 305, and cover plate 306. In some embodiments, 301/302/303/304 are all implemented on a circuit board 307. Piezoelectric ceramic 305 includes electrodes 309 and 310. Electrodes 309 and 310 are connected to the piezoelectric ceramic control unit 303 and the capacitance sensing unit 304. The entire system is built on support bracket 308.

When pressure is applied to (e.g., a finger presses on) the cover plate 306, the main controller 301 will obtain the pressure value of the piezoelectric ceramic 305 acting as a pressure sensor through the capacitance sensing unit 304. When the pressure reaches a certain threshold, the main controller 301, based on the pressure magnitude, will apply different voltages through piezoelectric ceramic control unit 303 to drive the piezoelectric ceramic 305 as an actuator to vibrate.

When piezoelectric ceramic 305 is used as an actuator, the capacitance variation can be detected by the capacitance sensing unit 304, which can be utilized to determine the current working state of the actuator. This working state is then compared with the expected state, and if it does not meet the expectations, the main controller 301 adjusts the working parameters of the piezoelectric ceramic drive 303 to make it meet expectations, completing a touch and vibration feedback closed-loop control process.

According to some embodiments, the main controller 301 may implement a control strategy that utilizes a proportional-integral-derivative (PID) controller to regulate the behavior of the piezoelectric actuator. A PID controller is a feedback control loop mechanism commonly used in various engineering applications to maintain a desired output or setpoint by adjusting a control input. In this case, the change in capacitance between the rotor and stator can be used as one of the control inputs.

As the actuator's position changes due to pressure changes, the distance between the rotor and stator changes, leading to a variation in capacitance. This change in capacitance can be measured and converted into a proportional signal representing the actuator's position.

The capacitance measurement serves as a feedback signal to the PID controller. Instead of relying solely on external position sensors, the capacitance measurement directly provides information about the actuator's position. This can potentially reduce the complexity and cost of the control system.

The change in capacitance can be directly related to the displacement of the actuator. The proportional (P) term of the PID controller can utilize this capacitance change to generate a control effort that is proportional to the position error. As the actuator deviates from the desired position, the PID controller can calculate a proportional correction based on the capacitance error.

The integral (I) and derivative (D) terms can also incorporate the capacitance measurement. The integral term can help eliminate any steady-state error due to capacitance-related changes over time. The derivative term can take into account the rate of change of capacitance, helping to prevent rapid changes in position that might be caused by sudden changes in capacitance.

In some cases, the capacitance change might not be linear or constant due to environmental factors or mechanical variations. Advanced control strategies, such as adaptive control, can use capacitance measurement to adjust the PID controller's parameters in real-time, enhancing the actuator's performance under varying conditions.

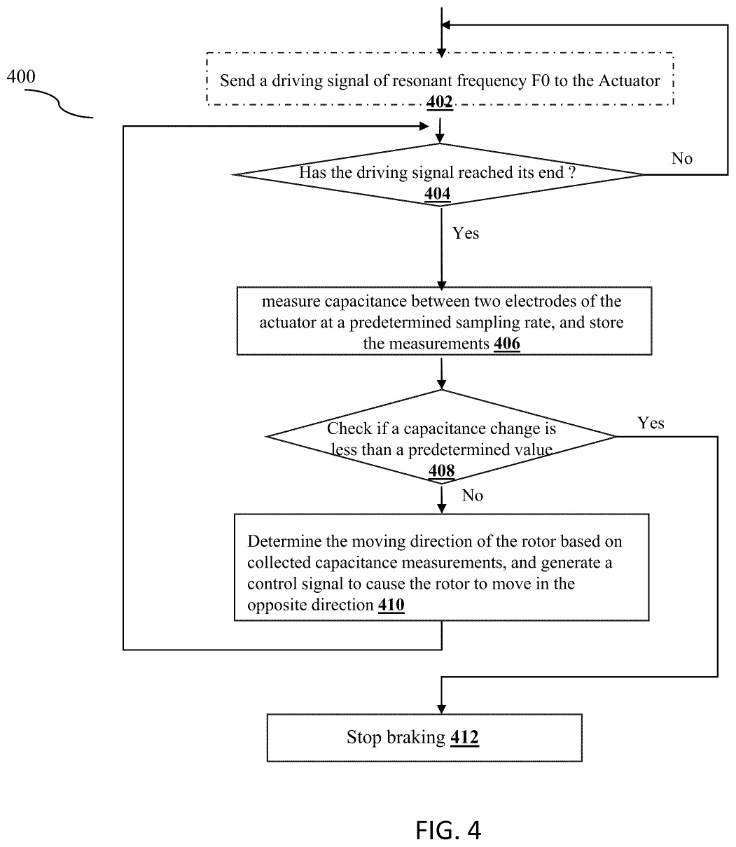

FIG. 4 illustrates method 400 for braking control of an LRA actuator based on capacitance feedback according to some embodiments of the present disclosure. The operations of method 400 presented below are intended to be illustrative. In some embodiments, method 400 may be accomplished with one or more additional operations not described and/or without one or more of the operations discussed. Additionally, the order in which the operations of method 400 are illustrated in FIG. 4 and described below is not intended to be limiting.

At an optional step 402, the Actuator controller (e.g., 202 in FIG. 2) sends a control signal to an LRA (e.g., 203 in FIG. 2). Because this LRA actuator is designed to operate at the resonant frequency F₀, the signal is typically an alternating current (ΔC) waveform with a frequency of F₀. Normally, the control signal lasts for a predetermined duration.

In step 404, the actuator controller ascertains if the control signal for the current operation has reached the end of the predetermined duration. In some embodiments, a time counter may be employed to monitor the predefined duration of the control signal. If the control signal is still ongoing, the operation iterates at this step. However, if the control signal has culminated or reached the end of the predetermined duration, indicating a need to brake the rotor, the process advances to step 406.

In step 406, actuator controller (e.g., 202 in FIG. 2) takes measurements of the capacitance between the two electrodes 207 and 208 at a predetermined sampling rate and stores these capacitance measurements for analysis later. The choice of sampling rate depends on the capabilities of the capacitance detection chip. Generally, a higher rate is preferable, and it should not typically fall below 200 Hz. For more detailed capacitance sensing circuits examples, please refer to FIGS. 3 and 4 and their corresponding descriptions of the U.S. Pat. No. 11,671,709, which is incorporated by reference herein.

In step 408, the stored capacitance measurements were analyzed to see if any capacitance change between two consecutive measurements is less than a predetermined value. This predetermined value is set to indicate whether to stop braking. If a capacitance change is less than the predetermined value, then the braking control can stop, i.e., the braking is deemed to have succeeded. The operation proceeds to step 412. If the magnitude of capacitance change remains greater than the predetermined threshold, then the operation proceeds to step 410.

In step 410, the stored capacitance measurements were further analyzed to determine the moving direction of the rotor. For example, according to some embodiments, as the rotor moves from the null position towards the positive maximum amplitude, it gets closer to the stator plate. The decreased distance between the rotor plate and the stator plate leads to an increase in the overlap area between the plates, resulting in an increase in capacitance. When the rotor moves from the null position towards the negative maximum amplitude, it moves away from the stator plate. The increased distance between the rotor and the stator plate leads to a decrease in the overlap area between the plates, resulting in a decrease in capacitance. Accordingly, to achieve rapid and efficient braking, the actuator controller would send a control signal to cause the rotor to move in the opposite direction, the actual parameters of the control signal depending on the measured capacitance. The process then goes back to step 406.

In some embodiments of the present disclosure, the control signal may consist of a series of waveforms with varying frequencies designed to identify or tune into the resonating frequency. As the actuator's maximum amplitude remains constant, we can calculate the maximum displacement of the system, denoted as Lₘₐₓ, based on the capacitance values Cₘₐₓ/Cₘᵢₙ detected by the capacitance detection circuit. If, for instance, the overall system's resonant frequency, denoted as F₀, experiences changes, perhaps due to normal physical wear and tear, we can then adjust the drive frequency to attain the maximum amplitude. This adjustment necessitates an update to the system's resonant frequency, typically stored in the actuator controller.

Though the method for controlling an actuator braking is disclosed by way of specific embodiments as described above, those embodiments are not intended to limit the present method. Based on the methods and the technical aspects disclosed herein, variations and changes may be made to the presented embodiments by those of skill in the art without departing from the spirit and the scope of the present method.

Also, while the embodiment described above specifically pertains to the braking function of an actuator, it is evident to those skilled in the art that the core principles of this invention can be analogously applied to various other functions associated with controlling an actuator. For instance, the invention's mechanisms can be adapted to modulate the speed of the actuator, to reverse its direction, or to introduce variable torque control. Hence, a person skilled in the art would appreciate the broader applicability of the invention beyond mere braking, embracing a spectrum of actuator control functionalities.

What is claimed is:

1. A method for controlling an actuator based on closed-loop feedback of capacitance measured between a rotor plate attached to a rotor and a stator plate attached to a stator, and the method comprising:
measuring, at a capacitance sensing unit of the actuator, capacitance between the rotor plate and the stator plate of the actuator at a predetermined sampling rate, and storing the measured capacitance;
calculating, at a processing unit, capacitance change of two consecutive capacitance measurements; and
generating, based on the calculated capacitance change, a control signal to control operation of the actuator.

2. The method of claim 1, wherein the actuator is one of a group consisting of an electromagnetic actuator, a linear resonant actuator, an eccentric rotating mass actuator, a rotary actuator, a piezoelectric actuator, a voice coil actuator, a Stepper Motor, a shape memory alloy actuator, an electroactive polymer actuator, and solenoids.

3. The method of claim 1, further comprising comparing the calculated capacitance change with a predetermined value to generate the control signal.

4. The method of claim 3, wherein the control signal is a braking signal.

5. The method of claim 3, further comprising determining the moving direction of the rotor based on the capacitance measurements.

6. The method of claim 1, further comprising measuring the capacitance between the rotor plate and an electrically conductive layer of the printed circuit board serving as the stator plate.

7. A method for controlling a linear resonate actuator in a control system, and the method comprising:
measuring, at a capacitance sensing unit of the closed-loop control system, capacitances between a rotor plate attached to a rotor and a stator plate attached to a stator of the linear resonant actuator;
determining position of the rotor based on the measured capacitance;
comparing the determined rotor position with predetermined expected position of the rotor; and
adjusting actuator working parameters of the linear resonant actuator based on the comparison.

8. The method of claim 7, wherein the working parameter is one from the group consisting of the resonance frequency, amplitude, driving voltage, waveform, duty cycle, mechanical load, the Q-factor and frequency range.

9. A method for controlling a piezoelectric ceramic actuator in a control system, and the method comprising:
measuring, at a capacitance sensing unit of the closed-loop control system, capacitances between a rotor plate attached to a rotor and a stator plate attached to a stator of the piezoelectric ceramic actuator;
determining position of the rotor based on the measured capacitance;
comparing the determined rotor position with predetermined expected position of the rotor; and
adjusting actuator working parameters of the linear resonant actuator based on the comparison.

10. The method of claim 9, wherein the working parameter is one from the group consisting of the resonance frequency, driving voltage amplitude, driving voltage, waveform shape, duty cycle, mechanical load.
